(19) United States
(12) Patent Application Publication
(10) Pub. No.: US 2015/0298556 A1
(43) Pub. Date: Oct. 22, 2015

(54) POWER SUPPLY DEVICE FOR VEHICLE

(71) Applicant: SANYO ELECTRIC CO., LTD., Osaka (JP)

(72) Inventors: HIDEKI SAKATA, Hyogo (JP); NOBUYUKI OHSUMI, Hyogo (JP); KAORU NAKAJIMA, Hyogo (JP); AKINOBU TSUNESADA, Hyogo (JP)

(73) Assignee: SANYO ELECTRIC CO., LTD., Osaka (JP)

(21) Appl. No.: 14/435,440

(22) PCT Filed: Oct. 24, 2013
(86) PCT No.: PCT/JP2013/006294

§ 371 Date: Apr. 13, 2015

(30) Foreign Application Priority Data
Oct. 29, 2012 (JP) 2012-238300

(51) Int. Cl. B60L 11/18; B60L 11/02

(52) U.S. Cl. CPC B60L 11/18; B60L 11/02

(57) ABSTRACT

A first power storage portion and a second power storage portion connected in parallel stores power generated by a generator in a vehicle and supplies power to an electric device in the vehicle. The second storage portion includes a plurality of series connected storage battery cells. The controlling portion monitors a ratio of divided voltages in the plurality of the series connected storage battery cells, and detects an abnormal state in the second power storage portion. Concretely, a positive terminal electrical potential, a negative terminal electrical potential, and a connecting node electrical potential are monitored, the abnormal state of the second power storage portion is determined when a ratio of a voltage between the positive terminal and the connecting node to a voltage between the negative terminal and the connecting node, does not correspond to a predetermined ratio.

### TECHNICAL FIELD

The present invention is related to a power supply device for vehicle installed in a vehicle.

### BACKGROUND ART

At present, a lead-acid battery is installed in many vehicles. This lead-acid storage battery supplies power to a starter motor, or many kinds of electric devices. The lead-acid storage battery is inexpensive, but has the characteristics of a short cycle life, compared with a nickel hydride storage battery or a lithium ion storage battery. In the vehicles having the idle stop function (the idle reduction function), as the number of charging and discharging is large, especially the life of the lead-acid storage battery becomes short.

### CITATION LIST

### Patent Literature

Patent Literature 1: Japanese Laid-Open Patent Publication No. 2011-176958

### SUMMARY OF THE INVENTION

Generally, a determination of a trouble in the storage battery is carried out by monitoring both-end voltage of it. In the case where the lead-acid storage battery, and the nickel storage battery or the lithium ion storage battery are connected in parallel as mentioned above, a voltage change of the one storage battery influences both-end voltage of the other storage battery. Therefore, the case where a state of the storage battery cannot be properly detected, might happen.

The present disclosure is developed for the purpose of such needs. One non-limiting and explanatory embodiment provides a technology which accurately detects a state of storage batteries connected in parallel.

A power source device for a vehicle of the present disclosure comprises a first power storage portion and a second power storage portion, connected in parallel, configured to store power generated by a generator in a vehicle and supplying power to an electric device in the vehicle, and a controlling portion configured to manage at least the second power storage portion. The second power storage portion includes a plurality of storage battery cells that connected in series. The controlling portion monitors a ratio of divided voltages in the storage battery cells, and detects an abnormal state in the second power storage portion.

In the present disclosure, a state of storage batteries connected in parallel can be accurately detected.

### BRIEF DESCRIPTION OF DRAWINGS

FIG. 1 is a figure showing a vehicle power supply device related to an embodiment of the present invention.

FIG. 2 is a figure explaining a second storage battery controlling portion of FIG. 1.

FIG. 3 is a block diagram showing a configuration example 1 of the second storage battery.

FIG. 4 is a flow chart explaining a trouble determination process of the second storage battery related to the configuration example 1.

FIG. 5 is a block diagram showing a configuration example 2 of the second storage battery.

FIG. 6 is a flow chart explaining a trouble determination process of the second storage battery related to the configuration example 2.

### DESCRIPTION OF EMBODIMENTS

Hereinafter, a vehicle power supply device related to embodiments of the present invention is explained. In the following explanation, the vehicle power supply device is installed in the vehicle having the idle stop function and the regenerative braking function.

In the idle stop function, an engine is automatically stopped at the time of stopping the vehicle, and the engine is automatically restarted at the time of starting the vehicle. In the regenerative braking function, power is generated by the regenerative braking in the inertia rotation of the engine without a fuel. Namely, an alternator operation during the normal driving is restricted, and the load of the engine is decreased. Both functions have an effect to improve a fuel efficiency.

In the vehicle having the idle stop function, the number of starting the engine is increased. Normally, the engine is started by a starter motor driven by a battery voltage. Therefore, as the number of starting the engine is increased, an electric power consumption is increased, and the number of discharging is increased. Further, in the vehicle having the regenerative braking function, as power is intensively generated at deceleration, a battery which has a large capacity and can be efficiently charged, is required.

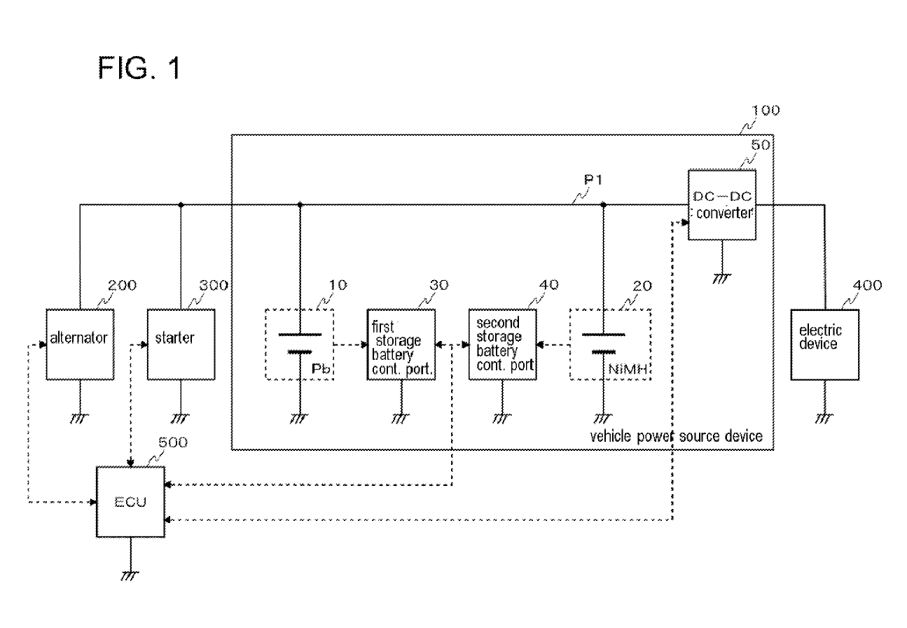

FIG. 1 is a figure showing a vehicle power supply device 100 related to an embodiment of the present invention. The vehicle which incorporates the vehicle power supply device 100, includes an alternator 200, an starter 300, an electric device 400, and an ECU (Electronic Control Unit) 500.

The alternator 200 generates power by a rotation energy of an crank shaft of the engine (not shown in the figures). In this embodiment, power is generated during deceleration. The alternator 200 supplies generated power to the vehicle power supply device 100.

The starter 300 is a motor for starting the engine. The starter 300 is rotated by power from the vehicle power supply device 100, and starts the engine. When an ignition switch (not shown in the figures) is turned on by an operation from a driver, power is supplied from the vehicle power supply device 100 to the starter 300, and the starter 300 starts.

The electric device 400 is a general term indicating many kinds of electric loads, such as, a headlight, a power steering, an oil pump, an car navigation system, an audio or the like. Here, in this specification, for convenience of explanation, the alternator 200, the starter 300, and the ECU are described in a separated state from the electric device 400. The electric device 400 is activated by power supplied from the vehicle power supply device 100.

The ECU 500 is connected to many kinds of auxiliary machinery, sensors, switches which are installed in the vehicle, and carries out electronic controls of the engine and many kinds of the auxiliary machinery. In the case that the idle stop function is carried out, when the ECU 500 detects the vehicle stopping or the deceleration less than a predetermined speed based on signals inputted from a brake, a vehicle speed sensor, or the like, the ECU 500 stops the engine. Then, the ECU 500 restarts the engine by detecting a release of the brake. At that time, the ECU 500 controls such that power is supplied form the vehicle power supply device 100 to the starter 300, and make the starter 300 operate.

In the case that the regenerative braking function is carried out, during the normal driving, the ECU 500 principally stops the alternator 200. When the ECU 500 detects the deceleration of the vehicle based on signals inputted from a brake, a vehicle speed sensor, or the like, the ECU 500 operates the alternator 200. Here, in the case that a battery capacity is less than a predetermined minimum capacity, the ECU 500 operates the alternator 200 even during the normal driving.

The vehicle power supply device 100 includes a first storage battery 10, a second storage battery 20, a first storage battery controlling portion 30, a second storage battery controlling portion 40, and a DC/DC converter 50. The first storage battery 10 as a main battery stores power generated by the alternator 200, and supplies power to the starter 300 and the electric device 400. The second storage battery 20 as a sub-battery stores power generated by the alternator 200, and supplies power to the electric device 400. The first storage battery 10 and the second storage battery 20 are connected in parallel.

In this embodiment, the first storage battery 10 is a lead-acid storage battery, and the second storage battery 20 is a nickel hydride storage battery. The lead-acid storage battery has merits that it is inexpensive, and is capable of operating in the considerably wide temperature range, and has a high output. Then, the lead-acid storage battery is widely used as a storage battery for the vehicle. However, the lead-acid storage battery has demerits that the energy efficiency of charging and discharging is low, and it is weak in over charge or over discharge, and it has a short cycle life. The nickel hydride storage battery has merits that the energy efficiency of charging and discharging is considerably high, and it is strong in over charge or over discharge, and it has a wide temperature range of the usage, a wide SOC (State Of Charge) range, and a considerably long cycle life. However, the nickel hydride storage battery has demerits that the self-discharge is large, it has a memory effect and a low output voltage, and it is more expensive than the lead-acid storage battery.

In the idle stop function, since the number of the usage of the starter 300 is increased, it is necessary to make the capacity of the storage battery large. The capacity of the lead-acid storage battery is not increased, but the capacity of the whole storage battery is increased, compensating for demerits of the storage batteries each other by using the combination of multiple types of the storage batteries having different characteristics.

In this embodiment, as one instance, the combination of the lead-acid storage battery and the nickel hydride storage battery is explained. It is possible that the lead-acid storage battery is combined with the lithium ion storage battery. The lithium ion storage battery is high in the energy density and the energy efficiency of charging and discharging, and is the storage battery of a high performance, but it is necessary to carry out the rigid voltage and temperature management.

Generally, the storage battery is disposed in the engine room. The nickel hydride storage battery is more suitable for disposing with the lead-acid storage battery in the engine room than the lithium ion storage battery. In the engine room, the temperature is increased while the engine works, and the nickel hydride storage battery has an excellent high-temperature resistance than that of the lithium ion storage battery. Here, in the case that the lithium ion storage which connected to the lead-acid battery is disposed at a distant location from the engine room, a loss on wiring resistance is increased.

The alternator 200, the starter 300, the first storage battery 10, the second storage battery 20, the electric device 400 are connected by a path P1. The DC/DC converter 50 is provided for voltage compensation such that the voltage of the above path P1 does not become a predetermined voltage or less at engine cranking and at restarting from a state of the idle stop. Generally, the above path P1 is designed at 12 V. In the electric device 400, once the input voltage of the car navigation system or the like decrease at about 10 V, it is reset. In order to prevent this, the ECU 500 activates the DC/DC converter 50 during operation of the starter 300, and then the electric potential of the charging and discharging terminal of the second storage battery 20 is stabilized, it can supply a stable voltage to the electric device 400.

The first battery controlling portion 30 manages or controls the first storage battery 10. Concretely, it obtains a voltage, a current, a temperature of the first storage battery 10, and monitors a remaining capacity and the presence or absence of the abnormal state of the first storage battery 10. The first storage battery controlling portion 30 informs the second storage battery controlling portion 40 of the remaining capacity of the first storage battery 10, and informs the ECD 500 of the normal state or the abnormal state of the first storage battery 10. The communication among the first storage battery controlling portion 30, the second storage battery controlling portion 40, and the ECU 500 is carried out, for example, by CAN (Controller Area Network).

The second storage battery controlling portion 40 manages or controls the second storage battery 20. The second storage battery controlling portion 40 is more concretely explained in the following.

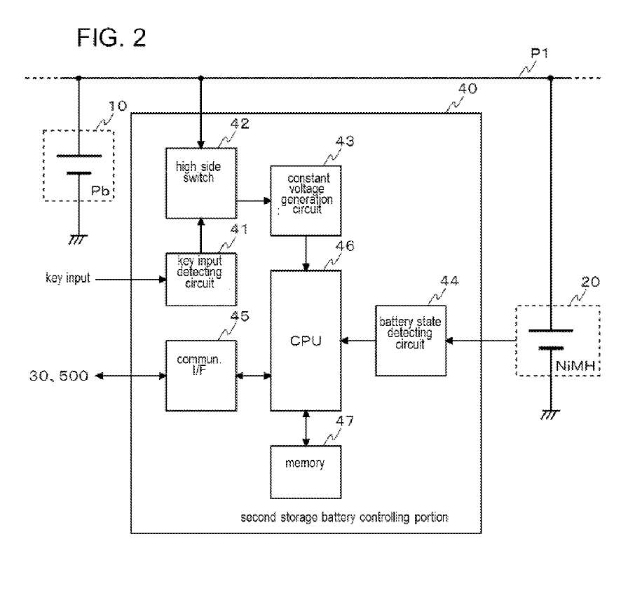

FIG. 2 is a figure explaining the second storage battery controlling portion 40 of FIG. 1. The second storage battery controlling portion 40 includes a key input detecting circuit 41, a high-side switch 42, a constant voltage generation circuit 43, a battery state detecting circuit 44, a communication interface 45, a CPU 46, and a memory 47.

The key input detecting circuit 41 detects insertion or removal of the ignition key. The key input detecting circuit 41 carries out the ON control of the high-side switch 42 when the driver inserts the ignition key, it carries out the OFF control of the high-side switch 42 when the ignition key is removed. Here, the key input detecting circuit 41 holds the high-side switch 42 OFF when the key position is OFF, and it carries out the ON control of the high-side switch 42 when the key position is ACC, ON, or START.

The high-side switch 42 is provided between the above path P1, and the constant voltage generation circuit 43. When the high-side switch 42 is turned on, the voltage of the above path P1 is supplied to the constant voltage generation circuit 43. The constant voltage generation circuit 43 generates a power source voltage of the CPU 46. For example, the voltage 12 V of the above path P1 is reduced to the voltage 3 to 5 V. For example, a three-terminal regulator can be used as the constant voltage generation circuit 43.

In this way, by inserting the ignition key, electric power is supplied to the CPU 46, and the second storage battery controlling portion 40 starts.

The battery state detecting circuit 44 obtains a voltage, a current, a temperature of the second storage battery 20. The battery state detecting circuit 44 informs the CPU 46 of the voltage, the current, the temperature of the second storage battery 20. The communication interface 45 is an interface for the communication among the second storage battery controlling portion 40 and other controlling circuits (the first storage battery controlling portion 30, the ECU 50 in this embodiment). The communication interface 45 transmits the information received from outside to the CPU 46, and transmits the information outputted from the CPU 46 to outside.

In this embodiment, the communication interface 45 transmits the abnormal detection of the second storage battery 20 or the second storage battery controlling portion 40 to the ECU 500. Moreover, it transmits the state information of the second storage battery 20 (for example, a voltage, a current, a temperature) to the ECU 500. In addition, it transmits the request of the power generation by the alternator 200 to the ECU 500. For the request of the power generation, SOC of the first storage battery 10 may be obtained from the first power storage battery controlling portion 30.

The CPU 46 controls the whole second storage battery controlling portion 40. The memory 47 stores a controlling program which is carried out by the CPU 46, and data generated by the CPU 46.

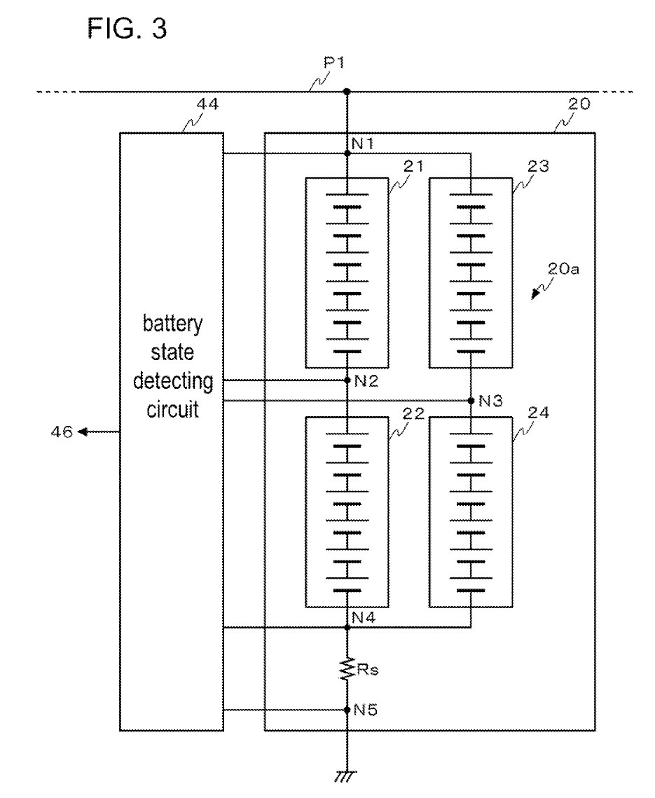

FIG. 3 is a block diagram showing configuration example 1 of the second storage battery 20. The second storage battery 20 includes a series-parallel connected circuit 20a of the plurality of the storage battery cells, and a shunt resistance Rs. In the configuration example 1, the series-parallel connected circuit 20a of ten series-two parallel is included. In FIG. 3, the series-parallel connected circuit 20a constitutes a combination of four storage battery modules. The one storage battery module includes five storage battery cells connected in series. A first storage battery module 21 and a second storage battery module 22 are connected in series, and a third storage battery module 23 and a fourth storage battery module 24 are connected in series. The series-connected circuits are connected in parallel as a series-parallel connected circuit 20a.

The positive terminal of the series-parallel connected circuit 20a is connected to the above path P1, and its negative terminal is connected to one end of the shunt resistance Rs. The other end of the shunt resistance Rs is connected to the ground. A battery state detecting circuit 44 is connected to each of a first node N1 between the positive terminal of the series-parallel connected circuit 20a and the above path P1, a second node N2 between the first storage battery module 21 and the second storage battery module 22, a third node N3 between the third storage battery module 23 and the fourth storage battery module 24, a fourth node N4 between the negative terminal of the series-parallel connected circuit 20a and the one end of the shunt resistance Rs, and a fifth node N5 between the other end of the shunt resistance Rs and the ground.

The battery state detecting circuit 44 detects the electrical potential of the first node N1 to the fifth node N5, and inform the CPU 46. The second storage battery 20 further includes a thermistor not shown in the figures, and a temperature which is detected by the thermistor is outputted to the battery state detecting circuit 44. The battery state detecting circuit 44 informs the CPU of the obtained temperature.

In this embodiment, the nickel hydride battery cells are used as the storage battery cells. As in the nickel hydride battery cells it is not necessary to carry out control of accurately equalizing voltages of the cells like the lithium ion storage battery cells, it is not necessary to detect voltages in each of the nickel hydride storage battery cells. In each of the series connected circuits which constitute the series-parallel connected circuit 20a, it is sufficient to detect both-end electrical potentials of it, and at least one node between the battery cells. In the configuration example 1, as the series connected circuit configures the series connection of the two storage battery module, the middle node of the two storage battery modules is monitored. Namely, a divided voltage node at which both-end voltage of the series-parallel connected circuit 20a is divided in the ratio of 1:1, is monitored.

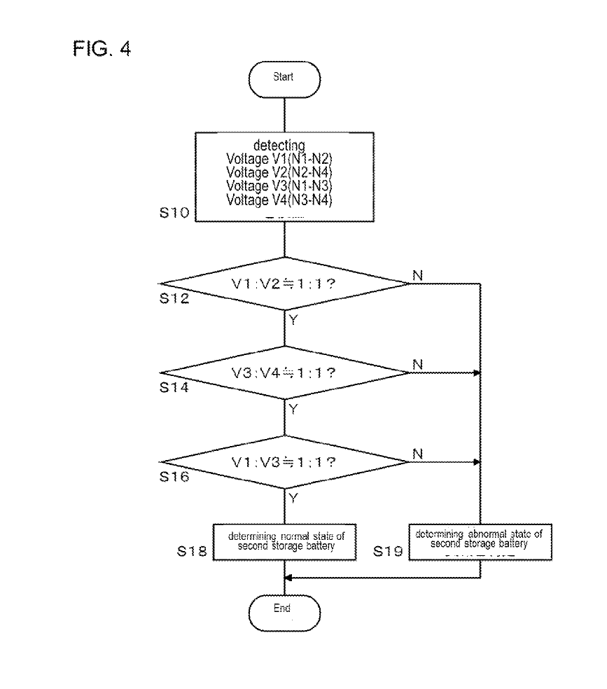

FIG. 4 is a flow chart explaining a trouble determination process of the second storage battery 20 related to the configuration example 1. The second storage battery controlling portion 40 respectively detects a first voltage V1 between the first node N1 and the second node N2, a second voltage V2 between the second node N2 and the fourth node N4, a third voltage V3 between the first node N1 and the third node N3, and a fourth voltage V4 between the third node N3 and the fourth node N4 (S10).

The second storage battery controlling portion 40 determines as to whether or not the ratio of the first voltage V1 to the second voltage V2 roughly coincides with a predetermined ratio of 1:1 (S12). As the second node N2 is the divided voltage node between the first storage battery module 21 and the second storage battery module 22 which respectively include the like number of the storage battery cells, when all of the storage battery cells in the first storage battery module 21 and the second storage battery module 22 are normal, the ratio of the first voltage V1 to the second voltage V2 is roughly in the ration of 1:1. In contrast, when a short circuit in any one of the storage battery cells occurs, the ratio of the first voltage V1 to the second voltage V2 is not in the ration of 1:1. For example, when the short circuit occurs in the one storage battery cell included in the first storage battery module 21, the ratio of the first voltage V1 to the second voltage V2 roughly becomes the ratio of 4:5.

When the ratio of the first voltage V1 to the second voltage V2 is not roughly in the ratio of 1:1 in step S12 (N of S12), the second storage battery controlling portion 40 determines the abnormal state of the second storage battery 20. At this time, by a relationship of magnitudes of the first voltage V1 and the second voltage V2, or those values, it can be understood if the first storage battery module 21 is abnormal or if the second storage module is abnormal. Fundamentally, it can be understood that the short circuit occurs in the storage battery module having a smaller voltage. When the second storage battery controlling portion 40 determines the abnormal state of the second storage battery 20, its abnormal information is notified to the ECU 500. When the ECU 500 receives this notification, the ECU carries out the control of stopping the alternator 200, the alert notification to a driver or the like.

When the ratio of the first voltage V1 to the second voltage V2 is roughly in the ratio of 1:1 in step S12 (Y of S12), the second storage battery controlling portion 40 determines as to whether or not the ratio of the third voltage V3 to the fourth voltage V4 roughly coincides with a predetermined ratio of 1:1 (S14). When the ratio of the third voltage V3 to the fourth voltage V4 is not roughly in the ratio of 1:1 (N of S14), the second storage battery controlling portion 40 determines the abnormal state of the second storage battery 20 (S19). Then, its abnormal information is notified to the ECU 500

When the ratio of the third voltage V3 to the fourth voltage V4 is roughly in the ratio of 1:1 in step S14(Y of S14), the second storage battery controlling portion 40 determines as to whether or not the ratio of the first voltage V1 to the third voltage V3 roughly coincides with a predetermined ratio of 1:1 (S16).

When the determination results of step S12 and step S14 are good, fundamentally it is understood the second storage battery 20 is normal. However, for example, when the short circuit occurs in the one storage battery cell in each of the first storage battery module 21 and the second storage battery module 22, as the ratio of the divided voltages is normal, there is some possibility that the first storage battery module 21 and the second storage battery module 22 are erroneously decided as normal. Therefore, by comparing the voltages of the storage battery modules connected in parallel, the trouble determination is more accurately carried out.

When the ratio of the first voltage V1 to the third voltage V3 is not roughly in the ratio of 1:1 (N of S16), the second storage battery controlling portion 40 determines the abnormal state of the second storage battery 20 (S19). Then, its abnormal information is notified to the ECU 500. When the ratio of the first voltage V1 to the third voltage V3 is roughly in the ration of 1:1 (Y of S16), the second storage battery controlling portion 40 decides the second storage battery 20 as normal (S18).

In place of a determination as to whether or not the ratio of the first voltage V1 and the third voltage V3 is roughly in the ratio of 1:1, or when its determination result is good, a determination may be made as to whether or not the second voltage V2 to the fourth voltage V4 is roughly in the ratio of 1:1.

Here, the second storage battery controlling portion 40 detects a current abnormal state (for example, an over current) by measuring a voltage between the fourth node N4 and the fifth node N5 (namely, both-end voltage of the shunt resistance Rs). Further, the second storage battery controlling portion 40 detects a temperature abnormal state based on a temperature by a thermistor not shown in the figures.

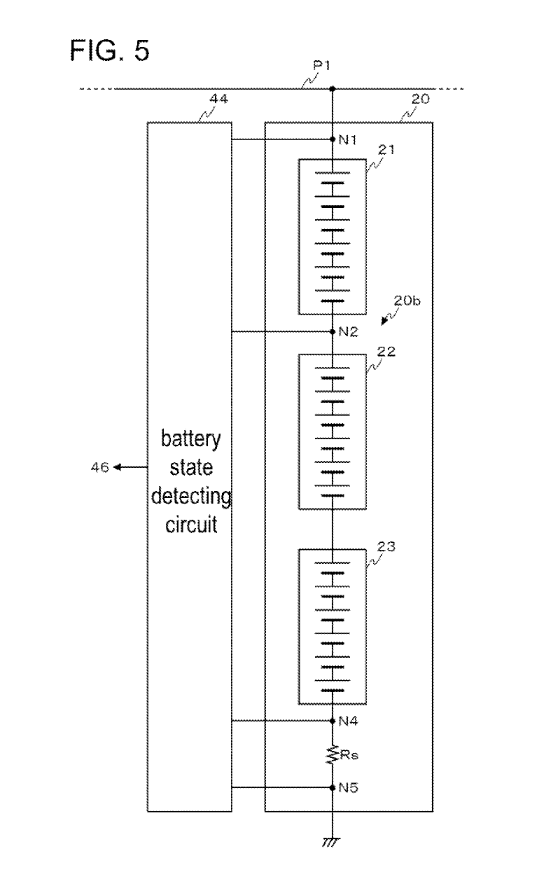

FIG. 5 is a block diagram showing a configuration example 2 of the second storage battery 20. The second storage battery 20 includes the series connected circuit 20b comprising the plurality of the storage battery cells, and the shunt resistance Rs. In the configuration example 2, the series connected circuit 20b of fifteen-series is included. In FIG. 5, the series connected circuit 20b constitutes a combination of three storage battery modules. The one storage battery module includes five storage battery cells connected in series. A first storage battery module 21, a second storage battery module 22, and a third storage battery module 23 are connected in series to configure the series connected circuit 20b.

The positive terminal of the series connected circuit 20b is connected to the above path P1, and its negative terminal is connected to one end of a shunt resistance Rs. The other end of the shunt resistance Rs is connected to the ground. A battery state detecting circuit 44 is connected to each of a first node N1 between the positive terminal of the series connected circuit 20b and the above path P1, a second node N2 between the first storage battery module 21 and the second storage battery module 22, a fourth node N4 between the negative terminal of the series connected circuit 20b and the one end of the shunt resistance Rs, a fifth node N5 between the other end of the shunt resistance Rs and the ground. In FIG. 5, the battery state detecting circuit 44 monitors a divided voltage node at which both-end voltage of the series connected circuit 20b is divided in the ratio of 1:2.

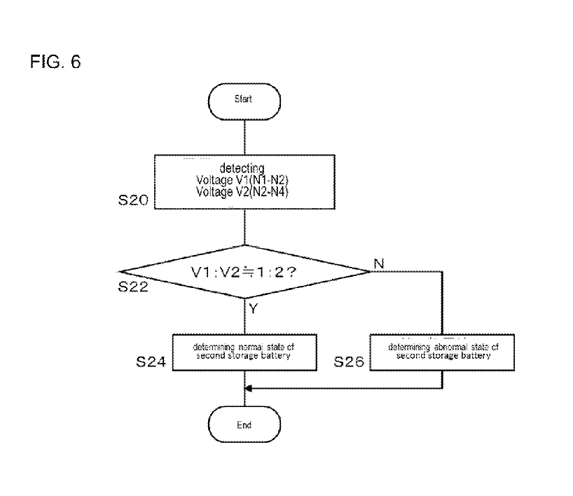

FIG. 6 is a flow chart explaining a trouble determination process of the second storage battery related to the configuration example 2. The second storage battery controlling portion 40 respectively detects a first voltage V1 between the first node N1 and the second node N2, a second voltage V2 between the second node N2 and the fourth node N4 (S20).

The second storage battery controlling portion 40 determines as to whether or not the ratio of the first voltage V1 to the second voltage V2 roughly coincides with a predetermined ratio of 1:2 (S22). When the ratio of the first voltage V1 to the second voltage V2 is not roughly in the ratio of 1:2 in step S12 (N of S22), the second storage battery controlling portion 40 determines the abnormal state of the second storage battery 20 (S26). When the ratio of the first voltage V1 to the second voltage V2 is roughly in the ratio of 1:2 in step S12 (Y of S22), the second storage battery controlling portion 40 determines the normal state of the second storage battery 20 (S24).

According to the embodiment explained above, the abnormal detection of the second storage battery 20 connected in parallel with the first storage battery 10, is accurately carried out by monitoring the ratio of the divided voltages in the plurality of the storage battery cells connected in series to configure the second storage battery 20. Namely, only by monitoring both-end voltage of the second storage battery 20, it might happen that the abnormal state cannot be detected by the influence of the voltage of the first storage battery 10 connected in parallel. Concretely, when the short circuit occurs in any one of the storage battery cells configuring the second storage battery 20, the positive electrical potential of the second storage battery 20 is decreased, but the positive electrical potential of the second storage battery 20 is kept by the voltage of the first storage battery 10.

In contrast, by monitoring the ratio of the divided voltages in the plurality of the storage battery cells connected in series to configure the second storage battery 20, even though the positive electrical potential of the second storage battery 20 is kept, as the ratio of the divided voltages is changed, the abnormal state of the second storage battery 20 can be detected without overlooking it. Further, as it is not necessary to monitor all nodes between the storage battery cells, it is sufficient to monitor the one node, and it is suppressed to increase the wirings. Here, by increasing the number of the monitoring nodes, it is easily to specify which storage battery cell is abnormal. Therefore, a designer may decide the number of the monitoring nodes, considering the trade-off between simplifying in the wirings and specifying the abnormal cell.

The above explanation is made based on the embodiments of the present invention. The person of the ordinary skill in the art can understand that these embodiments are illustrated, and these constitution elements and these combined processes can be modified, and such modified examples are covered by the scope of the present invention.

In the above embodiment, the first storage battery 10 and the second storage battery 20 are respectively managed and controlled by two controlling circuits of the first storage battery controlling portion 30 and the second storage battery controlling portion 40. However, the first storage battery 10 and the second storage battery 20 can be managed and controlled by one controlling circuit.

A fuse can be inserted between the above path P1 and the second storage battery 20. In this case, the second storage battery 20 is protected from a large current.

### REFERENCE MARKS IN THE DRAWINGS

100: vehicle power source device

200: alternator

300: starter

400: electric device

500: ECU

10: first storage battery

20: second storage battery

20a: series-parallel connected circuit

20b: series connected circuit

21: first storage battery module

22: second storage battery module

23: third storage battery module

24: fourth storage battery module

Rs: shunt resistance

30: first storage battery controlling portion

40: second storage battery controlling portion

50: DC/DC converter

41: key input detecting circuit

42: high-side switch

43: constant voltage generation circuit

44: battery state detecting circuit

45: communication interface

46: CPU

47: memory

1. A power source device for a vehicle comprising:
a first power storage portion and a second power storage portion, connected in parallel, configured to store power generated by a generator in a vehicle, and supplying power to an electric device in the vehicle; and
a controlling portion configured to manage at least the second power storage portion,
wherein the second power storage portion includes a plurality of storage battery cells that connected in series, and
the controlling portion monitors a ratio of divided voltages in the storage battery cells, and detects an abnormal state in the second power storage portion.

2. The vehicle power source device according to claim 1,
wherein the controlling portion monitors a positive terminal electrical potential, a negative terminal electrical potential, and a connecting node electrical potential of the storage battery cells, and determines the abnormal state of the second power storage portion when a ratio of a voltage between the positive terminal and the connecting node to a voltage between the negative terminal and the connecting node, does not correspond to a predetermined ratio.

3. The vehicle power source device according to claim 1,
wherein the second power storage portion includes a first storage battery cell group in which a plurality of storage cells are connected in series, and a second battery cell group in which a plurality of power storage cells are connected in series, and
the first storage battery cell group and the second battery cell group are connected in parallel, and
the controlling portion monitors the positive terminal electrical potential, the negative terminal electrical potential in the first storage battery cell group and the second battery cell group, and a first connecting node electrical potential of the first storage battery cell group and a second connecting node electrical potential of the second battery cell group, and determines the abnormal state of the second power storage portion when a ratio of a voltage between the positive terminal and the first connecting node to a voltage between the positive terminal and the second connecting node, does not correspond to a predetermined ratio, or when a ratio of a voltage between the first connecting node and the negative terminal to a voltage between the second connecting node and the negative terminal does not correspond to a predetermined ratio.

4. The vehicle power source device according to claim 1,
wherein the first power storage portion includes a lead-acid storage battery, and the second power storage portion includes a nickel hydride storage battery cell.

5. The vehicle power source device according to claim 2,
wherein the first power storage portion includes a lead-acid storage battery, and the second power storage portion includes a nickel hydride storage battery cell.

6. The vehicle power source device according to claim 1,
wherein the first power storage portion includes a lead-acid storage battery, and the second power storage portion includes a nickel hydride storage battery cell.
